(19) United States
(12) Patent Application Publication
(10) Pub. No.: US 2010/0009153 A1
(43) Pub. Date: Jan. 14, 2010

(54) CONDUCTIVE INKS AND PASTES

(75) Inventors: Zhihao Yang, Vestal, NY (US); Zhiyoung Xu, Endicott, NY (US); Yu Du, Vestal, NY (US)

Correspondence Address: FOLEY AND LARDNER LLP;SUITE 500, 3000 K STREET NW, WASHINGTON, DC, 20007, US

(73) Assignee: NanoMas Technologies, Inc.

(21) Appl. No.: 12/483,190

(22) Filed: Jun. 11, 2009

Related U.S. Application Data
(60) Provisional application No. 61/061,076, filed on Jun. 12, 2008.

(51) Int. Cl. B32B 27/00; H01B 1/12; B05D 5/12

(52) U.S. Cl. 428/220; 252/519.33; 427/126.1

(57) ABSTRACT

A composition comprises at least one silver nanoparticulate material, at least one conductive microparticulate material, and less than about 3% wt of an organic or polymeric resin. The composition provides a low curing temperature and upon cure good film properties. Also provided herein is a method of using an ink or paste, comprising: (i) providing the ink or paste comprising at least one silver nanoparticulate material, at least one conductive microparticulate material, and less than about 3% wt of an organic or polymeric resin; and (ii) curing the ink or paste at a temperature at lower than about 200° C. to decompose the organic resin.

### RELATED APPLICATION

This application claims priority to U.S. provisional application No. 61/061,076, filed Jun. 12, 2008, which is herein incorporated by reference in its entirety.

### BACKGROUND

All of the references cited herein are incorporated by reference in their entirety.

A variety of conductive inks or pastes have been used in various applications. See, e.g., U.S. Pat. Nos. 5,891,367; 5,652,042; 4,747,968; and U.S. application Ser. Nos. 10/551,168 and 09/900,925. For example, conductive silver inks and pastes can be used in electronics applications. Known silver inks and pastes can comprise silver micro-powders, particles, or flakes as the conductive component. In order to bind the powder, particles or flakes together, thermal curable or UV curable polymeric resins are generally used. Various conductive ink and paste compositions with such resins have been disclosed by U.S. Pat. Nos. 4,391,742; 4,410,457; 4,732,702; 5,043,102; 5,087,314; 5,158,708; 6,322,620; 7,157,507; and 7,524,893. However, the polymeric resins can significantly degrade the electrical conductivity of the silver inks and pastes, thereby adversely limiting their applications. For example, conductive silver inks and pastes, comprising polymeric resins, in general can have a volume resistivity higher than 10⁻⁴ ohm-cm after the inks and pastes are cured.

Other approaches to increase the overall conductivity of the silver inks and pastes include thermally heating up the inks and pastes to a high temperature, normally above 700° C., to “burn off” the organic moieties while sintering the microparticles and flakes. Nevertheless, the high temperature can also limit the applications of the conventional silver inks and pastes during manufacturing steps of electronic devices. It has been found that the metal nanoparticle inks and pastes, while showing superior performance as thin films, can form films with reduced electrical conductivity when the film thickness increase, such as more than 1 micron. As pointed out by Wang et al. in “Sintering Metal Nanoparticle Films” IEEE Flexible Electronics and Displays Conference and Exhibition 2008, the silver nanoparticles normally would have 10% to 15% organic surface stabilizing agents, which can contribute to about 40% to 50% volume shrinkage during curing. As a result, for thicker films (e.g., thicker than 1 micron), it can cause material cracks due to the internal stress created by the volume shrinkage.

Therefore, a need exists to have relatively resin-free conductive silver inks or pastes that can be cured at a low temperature.

### SUMMARY

Embodiments described herein include compositions, devices, methods of making compositions and devices, and methods of using compositions and devices.

One embodiment provides a composition comprising at least one silver nanoparticulate material, at least one electrically conductive microparticulate material, and less than about 3% wt of an organic or polymeric resin, wherein the composition has a curing temperature of less than about 200° C.

Also provided herein is a method of using an ink or paste, comprising: (i) providing the ink or paste comprising at least one silver nanoparticulate material, at least one electrically conductive microparticulate material, and less than about 3% wt of an organic or polymeric resin; and (ii) curing the ink or paste at a temperature at lower than about 200° C.

Another embodiment provides a composition comprising at least one silver nanoparticulate material and at least one electrically conductive microparticulate material, wherein the composition is substantially free of an organic or polymeric resin.

In another embodiment, a method of using an ink or paste is provided, the method comprising: (i) providing the ink or paste comprising at least one silver nanoparticulate material and at least one electrically conductive microparticulate material, wherein the ink or paste is substantially free of an organic or polymeric resin; and (ii) sintering the silver nanoparticulate material and the conductive microparticulate material at a temperature lower than about 200° C.

Another embodiment provides a composition comprising a plurality of particles comprising a plurality of nanoparticles and a plurality of microparticles, wherein the particles can be characterized by a particle size distribution curve comprising at least two peaks in the particle size distribution curve, wherein one peak is associated with the nanoparticles and one peak is associated with the microparticles, wherein the composition is substantially free of organic or polymeric resin.

Another embodiment provides a composition prepared by mixing a plurality of nanoparticles with a plurality of microparticles, the composition being substantially free of organic or polymeric resin.

Another embodiment provides a composition comprising a solvent carrier, and at least one silver nanoparticulate material, at least one electrically conductive microparticulate material, and less than about 3% wt of an organic or polymeric resin with respect to the weight of silver nanoparticulate material and electrically conductive microparticulate material, wherein the composition upon solvent carrier removal has a curing temperature of less than about 200° C.

Additional embodiments include compositions prepared by these methods including use of sintering or curing steps.

At least one advantage for at least one embodiment is relatively low curing temperature.

At least one additional advantage for at least one embodiment is relatively low resistivity.

At least one additional advantage for at least one embodiment is relatively good film properties including integrity and adhesion.

### BRIEF DESCRIPTION OF THE DRAWINGS

FIG. 1 provides a cross-sectional scanning electron micrograph (SEM) of a sample in one embodiment, the micrograph showing the silver nanoparticles and microflakes sintered and bonded together to form an integrated microstructure.

FIG. 2 provides a top view SEM image of the sample as shown in FIG. 1.

FIG. 3 provides a top view SEM image of a sample in one embodiment produced with silver microflakes.

### DETAILED DESCRIPTION

All references cited herein are hereby incorporated by reference in their entirety.

Particle size can be average particle size for mixtures of particles.

### Metal, Silver Nanoparticulate Material

Examples of nanoparticles of electrically conductive materials can include Ag, Au, Cu, Pt, Pd, Al, Sn, In, Bi, ZnS, ITO, or combinations thereof. Metal materials and nanoparticles are known in the art.

Nanoparticulate material properties can differ from their counterpart bulk materials. For example, one characteristic feature of the nanoparticles is their size-dependent surface melting point depression. (Ph. Buffat et al., Physical Review A, Volume 13, Number 6, June 1976, p 2287-2297; A. N. Goldstein et al., Science, Volume 256, Jun. 5, 2002, p 1425-1427; and K. K. Nanda et al., Physical Review A 66 (2002), p 013208-1 thru 013208-8) This property can enable the melting and/or sintering of the metal nanoparticles into a polycrystalline film with high electric conductivity. An example is provided in U.S. application No. 2007/0175296 to Subramanian et al. Also, in order to process the nanoparticle inks on plastic substrate, it is often desirable to lower the particle sintering temperature to below the glass transition temperature (Tg) of the substrate materials, generally less than about 250° C., such as less than about 200° C. Most often, the nanoparticles in this type of ink or paste have a diameter less than about 100 nm, such as less than about 50 nm, such as between about 1 nm and 20 nm, such as 1 nm and 10 nm.

U.S. application Ser. No. 11/734,692 to Yang et al. discloses a method of fabricating silver nanoparticles and demonstrates sintering at a low temperature (less than 200° C.) with the processed conductive thin films having a volume resistivity such as about 2.3×10⁻⁶ ohm-cm or less. The ink or paste provided herein can also overcome the challenge of only being able to form thin films, and the ink or paste can be formed into a film with a thickness greater than about 0.5 μm, such as greater than about 1 μm, such as greater than or equal to about 2 μm, such as greater than or equal to about 3 μm, such as greater than or equal to about 5 μm, such as greater than or equal to about 10 μm.

One example of the electrically conductive nanoparticulate is silver nanoparticles. Methods of fabricating silver nanoparticles can be found in for example U.S. application Ser. No. 11/734,692 to Yang et al. In this example, one precursor material is a silver ion containing agent, such as silver acetate, which is dissolved in a first solvent such as toluene, and another precursor material is a reduction agent such as sodium borohydrite, NaBH₄, which is dissolved in a second solvent immiscible with the first solvent such as water. There are other reduction agents such as LiBH₄, LiAlH₄, hydrazine, ethylene glycol, ethylene oxide based chemicals, and alcohols, etc. These precursor materials in the immiscible solvents are mechanically mixed with the presence of a surface stabilizing agent for the silver nanoparticles. The surface stabilizing agents could be a substituted amine or a substituted carboxylic acid with the substituted groups having 2 to 30 carbons. The surface stabilizing agent capped silver nanoparticles, with size ranging from 1 to 1000 nm, preferably from 1 to 100 nm, more preferably from 1 to 20 nm, most preferably from 2 to 10 nm, are produced.

The nanoparticles formed in accordance with this method can exhibit special properties due to their relatively high monodispersity in diameter, namely between about 1 nm and about 20 nm. For example, the Ag nanoparticle melting temperature is significantly reduced from its bulk melting temperature of 962° C. to lower than about 200° C. This property will allow nanoparticles to form electrically conductive patterns or tracks on a substrate when processed at a temperature lower than 200° C., such as lower than about 180° C., such as lower than about 150° C. These materials are found to have wide applications in fabricating printed electronic devices on substrates.

### Electrically Conductive Microparticulate Material

Electrically conductive microparticulate materials are known in the art. In one embodiment, the conductive microparticulate material can comprise silver. Alternatively, the conductive microparticulate material can comprise Au, Cu, Pt, Pd, Al, Sn, In, Bi, ZnS, ITO, or combination thereof, including combinations with silver. In another embodiment, the conductive microparticulate material is in the form of flakes, such as micro-flakes.

Less than about 3% Wt. of an Organic or Polymeric Resin

Inks or pastes commonly can comprise metal particles and at least one organic or polymeric resin; see, for example, Ukita et al., Advancing Microelectronics, September/October (2005), p 8, and/or U.S. Pat. No. 7,198,736 to Kasuga et al. Compositions as described herein can be formulated totally without or substantially without any organic or polymeric resin.

Organic resins are viscous liquids capable of hardening. They can be natural, such as those derived from plants such as pine, or synthetic such as an epoxy resin made through polymerization-polyaddition or polycondensation reactions. Resins can provide binding between the particles in the ink or paste during curing. Curing refers to the toughening or hardening of a polymeric material by cross-linking of the polymer chains. It can be initiated by for example chemical additives, UV radiation, electron beam, or heat.

One adverse result of organic resin is that it can significantly decrease the electrical conductivity of the ink or paste. For example, in the presence of organic resin, the addition of nano-sized silver particles to micro-sized silver particles as fillers in the conductive adhesives can increase the electrical resistivity, or “volume resistivity,” of the material, as shown by Ye, et al. IEEE Transactions on Electronics Packaging Manufacturing, Vol. 22, p 299-302 (1999) One general method to avoid this problem is to burn off the organic resin from the ink or paste, but the temperature generally used can be so high (e.g., greater than 700° C.) that the burning off process can limit the applications of the device that comprises the ink or past.

One embodiment provides herein a substantially resin-free composition comprising a conductive silver ink or paste that can be cured and processed at a temperature lower than about 200° C. to about 250° C., such as about 130° C. to about 180° C., such as about 150° C. to about 160° C., to form highly conductive interconnects in electronic devices. The conductive ink or paste can further comprise at least one silver nanoparticulate material (NanoMas, Inc., New York), at least one conductive microparticulate material, such as silver microparticulate material, such as silver micro-flakes (Metalor, Inc., Switzerland), or a combination thereof. In another embodiment, the composition comprises a small amount of organic or polymeric resin, such as less than about 10% wt, such as less than about 5% wt., such as less than about 3% wt, such as less than about 2% wt, such as less than about 1% wt, or less than about 0.1% wt, or less than about 0.01% wt.

### Solvents/Ink Carrier

Solvents and dispersant liquids are generally known in the art and can be used to prepare particulate materials and disperse the particles in ink or paste formulations. Suitable solvents can be aqueous or organic in nature and comprise more than one component. A solvent can be adapted to dissolve or highly disperse a component such as, for example, a nanoparticulate material, a microparticulate material, a surface stabilizing agent, a reactive moiety, an organic resin, or combinations thereof. Solvents may be chosen based on the desired mixture type, solubility of solutes and/or precursors therein or other factors. Solvents used in the formulation of the conductive silver nanoparticle inks and/or pastes also can be removed by evaporation or drying.

In one embodiment, at least two solvents phase-separate after combination of the mixtures. Phase-separation may be understood as two separate liquid phases observable with the naked eye. Water can be used in a purified form such as distilled and/or deionized water. The pH can be ordinary, ambient pH which may be somewhat acidic because of carbon dioxide. For example, pH can be about 4 to about 10, or about 5 to about 8.

In some embodiments, one or more solvents comprise saturated or unsaturated hydrocarbon compounds. Said hydrocarbon compounds may further comprise aromatic, alcohol, ester, ether, ketone, amine, amide, thiol, halogen or any combination of said moieties. In one embodiment, the first solvent comprises an organic solvent and the second solvent comprises water. In another embodiment, the first solvent comprises a hydrocarbon and the second solvent comprises water.

### Ink or Paste Formulation

Inks or pastes can be formed from the nanoparticles, such as silver nanoparticles, or a combination of nanoparticles, such as silver nanoparticles, and conductive particulates of larger dimensions.

The fabrication methods of the nanoparticulate material can be found in, for example, U.S. application Ser. No. 11/734,692 to Yang et al. In addition, the conductive ink or paste can optionally comprise a small amount of organic or polymeric resin, such as less than about 5% wt, such as less than about 3% wt, such as less than about 2% wt, including less than about 1% wt. Alternatively, the ink or paste can comprise substantially no organic resins or precursors to form organic resins. In another embodiment, the ink or paste is entirely free of an organic or polymeric resin. The silver nanoparticulate material can be sintered at a temperature lower than about 200° C., such as about lower than about 180° C., such as lower than about 150° C., for example during curing, and can bind the silver microparticulate material together to form a highly conductive silver metallic material.

In one embodiment, the silver nanoparticulate material can comprises nanoparticles with dimensions less than about 50 nm, such as less than about 20 nm, such as less than about 10 nm, such as less than about 5 nm, and the conductive microparticulate material can comprise conductive microparticles or flakes with at least one dimension larger than about 1 micron but less than about 100 microns, such as larger than about 1 micron but less than about 50 microns, such as larger than about 1 μm but less than about 20 microns. The microparticulate material and nanoparticulate materials can each be in any suitable shape. For example, they can be spherical particles, elliptical particles, rods, flakes. They can each have relatively uniform distribution of size, or, alternatively, they can have a non-uniform distribution of size. They can be resent in the ink or paste in any ratio. For example, the weight ratio of the nanoparticulate to the microparticulate material can be, for example, 10:1 to 1:10, or 5:1 to 1:5, or 3:1 to 1:3, or about 10:1, 5:1, 3:1, 2:1, 1:1, 1:2, 1:3, 1:5, 1:10, or smaller or greater.

In another embodiment, the conductive ink or paste comprises a solvent or a mixture of solvents, in which both the silver nanoparticulate material and the conductive microparticulate material can be dispersed. In one embodiment, the conductive microparticulate material can comprise silver. Alternatively, the conductive microparticulate material can comprise Au, Cu, Pt, Pd, Al, Sn, In, Bi, ZnS, ITO, or combination thereof. In another embodiment, the conductive microparticulate material is in the form of flakes, such as micro-flakes.

The ink and/or paste that is substantially resin-free or contains a small amount of organic or polymeric resin, such as less than 5% wt, such as less than 3% wt, after curing and/or sintering can be used to form a film, which can be a continuous film. The ink or paste can be deposited onto a substrate by various printing techniques known to one of ordinary skill in the art. For example, the ink or paste can be printed on to a substrate by techniques such as gravure printing, flexographic printing, offset printing, and screen printing.

The silver ink or paste described above can be a part of an electronic device. For example, the silver conductive ink or paste can be used to form electric interconnects in printed circuit boards and electronic device packaging. Additionally, it can be used to fabricate electronic devices, such as antennae for radio-frequency identification (“RFID”), various kinds of solar cells, sensors.

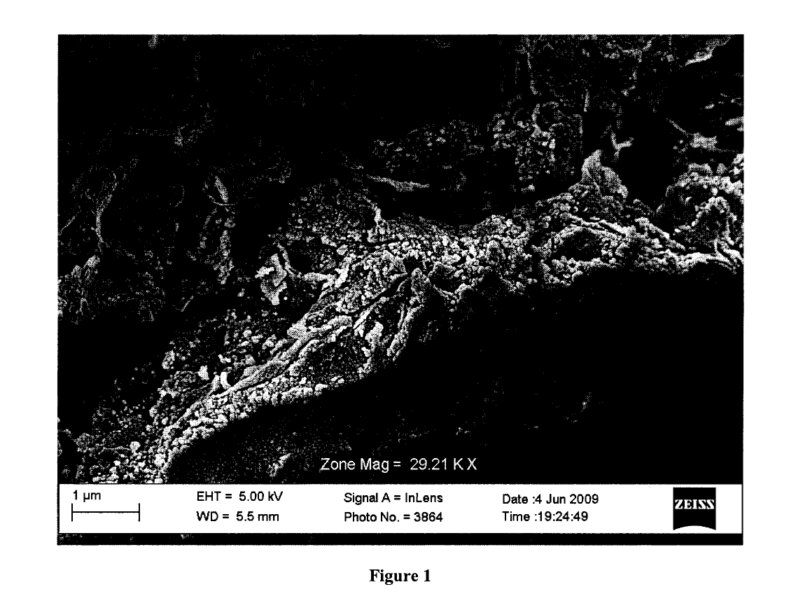

An alternative embodiment provides a ink or paste composition comprising silver nanoparticle and a conductive microparticulate material can be sintered and/or cured and processed at a temperature lower than about 200° C., such as lower than about 180° C., such as lower than about 150° C., to form highly conductive interconnects in electronic devices. The nanoparticle and microparticle can be sintered and integrated after curing. In one embodiment (see e.g., FIG. 1), a cross-sectional SEM image can show that the silver nanoparticles can be sintered around the microflake conductive microparticulate materials and bond the microflakes together to form an integrated material structure.

The conductive ink or paste can comprise at least one silver nanoparticulate material, at least one conductive microparticulate material, or a combination thereof, and the conductive ink or paste can also optionally comprise an organic resin that can be thermally decomposed in the matrix at a temperature lower than about 200° C. The amount of resin can be small, such as less than about 5% wt, such as less than 3% wt. The silver nanoparticulate material and the conductive microparticulate material, or a combination thereof, can amount to, for example, between about 0%-100%, such as about 1% to 99%, such as 5% to about 95%, such as about 10% and about 90% of the ink or paste, or for example about 20% to about 70%, or for example about 40% to about 60% of the ink or paste. In addition, during curing the silver nanoparticulate material can be sintered at a temperature lower than about 200° C. and can bind the conductive microparticulate material together to form a highly conductive material. The curing process can also provide the cured and/or sintered ink or paste with desirable mechanical properties, such as structural integrity and adhesion, for the highly conductive materials. The curing time can be relatively short. For example, it can take about less than 20 minutes, such as less than 10 minutes, less than about 5 minutes, or less than about 3 minutes to complete the process of curing. After curing, the ink or paste can be substantially free of the organic or polymeric resins.

The ink or paste comprising both nanoparticulate and microparticulate materials can have better mechanical properties than one comprising substantially only either nanoparticulate or microparticulate material. In one embodiment, the ink or paste that contains only microparticles may not have sufficient structural integrity to form a film after curing. Furthermore, the ink or paste comprising both types of materials after curing can have a relatively low electrical resistivity (i.e., a high electrical conductivity). For example, it can have an electrical resistivity, or volume resistivity, after curing of less than about 10⁻³ Ohms-cm, such as less than about 10⁻⁴ Ohms-cm, such as less than about 5×10⁻⁵ Ohms-cm, such as less than about 1.3×10⁻⁵ Ohms-cm, such as less than about 1×10⁻⁵ Ohms-cm. Additionally, the ink or paste can also be better suited for thick film applications with the thickness of more than about 0.5 microns, such as more than about 1 micron, such as more than about 2 microns, such as more than about 3 microns, such as more than about 10 microns, than its nanoparticulate or microparticulate ink or paste counterparts because of the relatively small volume shrinkage during curing.

Particle size distribution curves can be also used to characterize the compositions. Known statistical and measurement methods can be used to evaluate particle size distribution. For example, another embodiment provides a composition comprising a plurality of particles comprising a plurality of nanoparticles and a plurality of microparticles, wherein the particles can be characterized by a particle size distribution curve comprising at least two peaks in the particle size distribution curve, wherein one peak is associated with the nanoparticles and one peak is associated with the microparticles, wherein the composition is substantially free of organic or polymeric resin. For the nanoparticle peak, average particle size can be less than one micron, and for the microparticle peak, average particle size can be greater than one micron. Other average particle sizes for the distribution curve are described herein.

### NON-LIMITING WORKING EXAMPLES

### Example 1

### Synthesis of Ag Nanoparticles

3.34 grams of silver acetate and 37.1 grams of Dodecylamine were dissolved in 400 ml of toluene. 1.51 grams of sodium borohydride (NaBH₄) was dissolved in 150 ml of water. The NaBH₄ solution was added drop-wise into the reaction flask through a dropping funnel over a period of 5 min while stirring. Keep stirring for the reaction of 2.5 hours and stop. The solution settled into two phases. The water phase was by a separation funnel, and a rotor evaporator was used to remove toluene from the solution, resulting in a highly viscous paste. 250 ml of 50/50 methanol/acetone was added to precipitate the Ag nanoparticles. The solution was filtrated through a fine sintered glass funnel and the solid product was collected and vacuum dried at room temperature. 2.3 to 2.5 grams of deep blue solid product were obtained. The nanoparticles had a size of about 4-5 nm as examined by TEM, and showed a sintering or particle fusion temperature of about 100-160° C. as examined by DSC. It was also shown by Small Angle Neutron Scattering experiments that the silver nanoparticles had a size of 4.6+/−1 nm.

### Example 2

### Resistivity Vs. Film Thickness with Silver Nanoparticle Only Inks and Pastes

Samples of ink and paste with silver nanoparticle concentration from 12.5% (wt) to 50% (wt) in cyclohexane were prepared. The silver nanoparticles were synthesized by the method of Example 1. A wire bar coater (GARDCO, Paul N. Gardner Corp.) was used to coat ink and paste on PET substrate (5 MEL ST505, TEKRA Corperation) with a set of bars of different wire size producing, wet film thickness from 7.6 microns to 30.5 microns. Coated samples were cured on a hot plate at 150° C. for about 5 minutes. The sheet resistances of the cured films were measured by a four point probe (Jandel probe head, Lucas Labs 302 test stand, and Keithley 2400 source meter) and corresponding volume resistivity were calculated based on the cured film thickness determined by SEM, and they are listed in Table 1.

TABLE 1
Resistivity of cured silver nanoparticles vs. the film thickness

| Thickness (μm) of cured | |
|---|---|
| silver nanoparticle films | Volume resistivity (ohm-cm) of the films |
| 0.15 | 2.2 × 10⁻⁵ |
| 0.3 | 3.6 × 10⁻⁵ |
| 0.6 | 6.4 × 10⁻⁵ |
| 0.8 | 8.9 × 10⁻⁵ |
| 1.6 | 1.4 × 10⁻⁴ |
| 2 | 2.5 × 10⁻⁴ |
| 3 | 8.1 × 10⁻⁴ |

The results show that while the cured silver nanoparticle thin films with thickness less than 0.5 micron, for example 0.15 micron, exhibited good material conductivity with low volume resistivity (e.g., 2.2×10⁻⁵ ohm-cm), the thicker films with thickness over 1 micron, for example 2 micron or 3 micron, had a higher resistivity, for example more than 10 folds higher than that of thinner films. Not to be bound by any particular theory, this can because substantially all silver nanoparticles with a size less than 50 nm normally can have an organic surface coating for stabilization. The loss of organic coatings during the curing would can cause a total volume shrinkage of the material. Such shrinkage in the thicker films can cause microscopic cracks within the material, therefore degrading the material conductivity.

### Example 3

### Conductive Silver Nanoparticle Inks and Pastes

In one embodiment, two kinds of silver particles were used to fabricate an ink. One was silver nanoparticles (NanoMas Inc., New York) with an average particle diameter of about 5 nm. The silver nanoparticles were synthesized by the method of Example 1. The other was flake-shaped silver microparticles (“microflakes”) from Metalor Technologies (product #: P408-4) with an average particle diameter of about 3 microns. For the experiments, five ink or paste samples were prepared as follows:

Sample 1: 50% (wt) of NanoMas silver nanoparticles in cyclohexane

Sample 2: 50% (wt) of silver microflakes (Metalor P408-4) in terpineol.

Sample 3: 1:1 mixture of sample 1 and 2 above:

50% (wt) of NanoMas silver nanoparticles/silver mircroflakes (Metalor P408-4) (50/50) in a mixed solvent of cyclohexane and terpineol.

Sample 4: 2:1 mixture of sample 1 and 2 above:

50% (wt) of NanoMas silver nanoparticles/silver microflakes (Metalor P408-4) (66.6/33.3) in a mixed solvent of cyclohexane and terpineol.

Sample 5: 3:1 mixture of sample 1 and 2 above:

50% (wt) of NanoMas silver nanoparticles/silver microflakes (Metalor P408-4) (75/25) in a mixed solvent of cyclohexane and terpineol.

A wire bar coater (GARDCO, Paul N. Gardner Corp.) was used to coat the ink and paste on PET substrate (5 MEL ST505, TEKRA Corperation) with a wire bar of wet film thickness 30.5 microns, resulting in final cured films of about 2 microns in thickness as verified by SEM. Coated samples were cured on a hot plate at about 150° C. for 5 minutes. The sheet resistances of the cured films were measured by a four point probe (Jandel probe head, Lucas Labs 302 test stand, and Keithley 2400 source meter). The volume resistivity were calculated from the measured resistivity, and shown in Table 2.

TABLE 2
Electrical Resistivity of the samples

| | Sheet resistance (ohm/sq) | Volume resistivity (ohm-cm) |
|---|---|---|
| Sample 1 | 1.74 | 2.5 × 10⁻⁴ |
| Sample 2 | Not measurable* | Not measurable* |
| Sample 3 | 0.067 | 1.3 × 10⁻⁵ |
| Sample 4 | 0.175 | 3.5 × 10⁻⁵ |
| Sample 5 | 0.278 | 5.6 × 10⁻⁵ |

*The material of coatings did not adhere and had no mechanical integrity, and thus the resistivity was not measurable.

The results show that the ink mainly comprising silver microflakes cannot be annealed at a temperature less than 200° C., for example, at about 150° C. By adding silver nanoparticles into the microparticles, the ink or paste was effectively annealed and/or sintered at a low temperature of about 150° C. The annealing of nanoparticles also provides bonding of the microflakes and thus desirable mechanical property for the material. This also improves the adhesion of the metal to the substrates. In Sample 3 and Sample 4, wherein silver nanoparticulate and silver microflakes were present in substantially comparable amount, the coatings from conductive inks or pastes showed much higher conductivity than those from an ink with only silver nanoparticles as in Sample 1, with a volume conductivity less than about 5×10⁻⁵ ohm-cm, while the material made with substantially free of organic or polymeric resin maintained its structural integrity made.

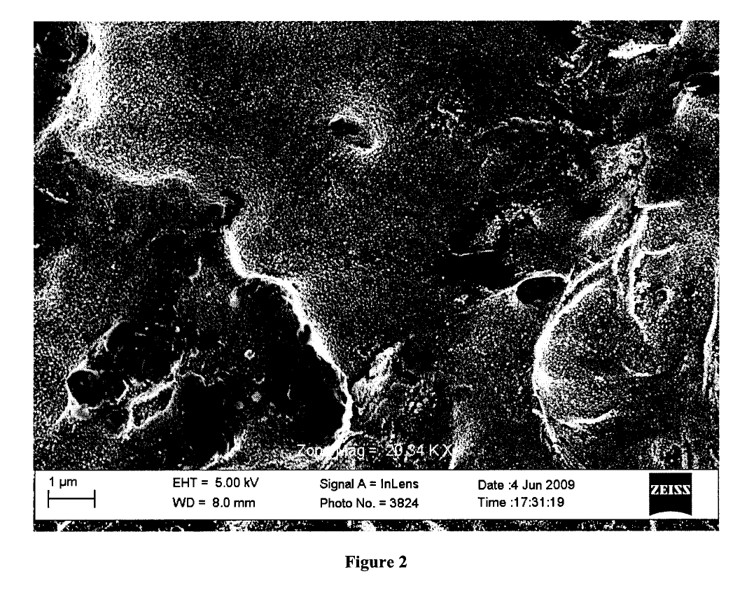

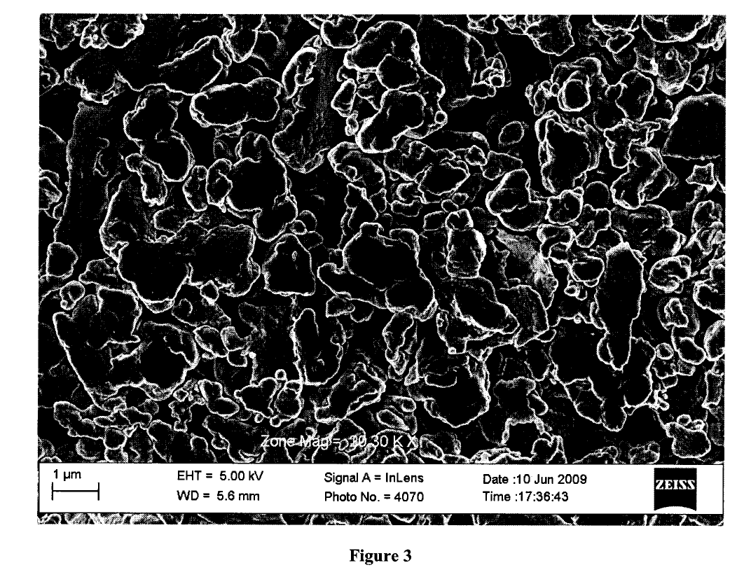

The microstructure of sample 3, wherein both silver nanoparticles and microparticulate materials were used, is provided in an illustrative SEM image in FIG. 1 (sample 3 above). FIG. 1 is a cross-sectional SEM image of a cured film, which was intentionally fractured mechanically to investigate the internal microstructures of the film, and FIG. 2 is a top view SEM image of the same sample. As shown in FIGS. 1 and 2, the silver nanoparticles were sintered around the microflakes and bonded the flakes together to form an integrated material structure so that adequate continuous phase is present. For comparison, a top view SEM image of a sample that contained only silver microflakes (Metalor P408-4) and was prepared as Sample 2 described above is provided in FIG. 3. As shown in FIG. 3, even after heat treatment at 150° C. for 5 minutes, the microparticulate mircoflakes were not sintered and did not form an integrated material structure, as demonstrated by the boundaries and gaps between the microflakes. Also, Sample 2 had no mechanical integrity, and thus the conductivity could not be measured.

Finally, the following embodiments are provided from U.S. provisional application No. 61/061,076:

1. A composition comprising at least one silver nanoparticulate material and at least one silver microparticulate material, wherein the composition is electrically conductive and has a low curing temperature.
2. The composition of embodiment 1, further comprising at least one organic resin.
3. The composition of embodiment 2, wherein the organic resin decomposes at a temperature lower than about 200° C.
4. The composition of embodiment 1, wherein the ink or paste is substantially free of organic resin.
5. The composition of embodiment 1, wherein the silver nanoparticulate material has a diameter less than about 20 nm.
6. The composition of embodiment 1, wherein the silver nanoparticulate material has a diameter less than about 10 nm.
7. The composition of embodiment 1, wherein the silver nanoparticulate material sinters and binds with the microparticulate material at a temperature lower than about 200° C.
8. The composition of embodiment 1, wherein the silver microparticulate material has a diameter larger than about 1 μm but less than about 100 μm.
9. The composition of embodiment 1, wherein the curing temperature is lower than about 200° C.
10. The composition of embodiment 1, wherein the composition is in the form of an ink or paste.
11. The composition of embodiment 1, wherein the composition after curing has an electrical resistivity of less than about 5 nOhms-m.
12. The composition of embodiment 1, wherein the nanoparticulate material and the microparticulate material are present in substantially the same amount.
13. The composition of embodiment 1, wherein the microparticulate material is in the form of flakes.
14. An electronic device comprising the composition of embodiment 1.
15. A method of using an ink or paste, comprising:
providing the ink or paste comprising at least one silver nanoparticulate material, at least one silver microparticulate material, and at least one organic resin; and
curing the ink or paste at a temperature lower than about 200° C. to decompose the organic resin.
   16. The method of embodiment 15, wherein curing further comprises sintering the at least one silver nanoparticulate material and the at least one silver microparticulate material.
   17. The method of embodiment 15, wherein curing takes less than about 5 minutes.
   18. The method of embodiment 15, wherein after curing the ink or paste is substantially free of organic resin.
   19. The method of embodiment 15, wherein the ink or paste after curing has an electrical resistivity of about 5 nOhms-m.
   20. The method of embodiment 15, further comprising depositing the ink or paste onto a substrate.
   21. The method of embodiment 23, wherein depositing is performed by gravure printing, flexographic printing, offset printing, or screen printing.
   22. A method of using an ink or paste, comprising:
providing the ink or paste comprising at least one silver nanoparticulate material, at least one silver microparticulate material; and
sintering the silver nanoparticulate material and the silver microparticulate material at a temperature lower than about 200° C.
   23. The method of embodiment 22, wherein after sintering the ink or paste is substantially free of organic resin.
   24. The method of embodiment 22, further comprising depositing the ink or paste onto a substrate.
   25. An ink or paste, comprising at least one silver nanoparticulate material and at least one silver microparticulate material; wherein the ink or paste is substantially free of organic resin, electrically conductive, and has a low curing temperature.
   26. The ink or paste of embodiment 25, wherein the silver nanoparticulate material has a diameter less than about 20 nm.
   27. The ink or paste of embodiment 25, wherein the silver nanoparticulate material sinters and binds with the microparticulate material at a temperature lower than about 200° C.
   28. The ink or paste of embodiment 25, wherein the silver microparticulate material has a diameter larger than about 1 μm but less than about 100 μm.
   29. The ink or paste of embodiment 25, wherein the nanoparticulate material and the microparticulate material are present in substantially the same amount.
   30. The composition of embodiment 25, wherein the microparticulate material is in the form of flakes.

This concludes the thirty embodiments.

What is claimed:

1. A composition comprising at least one silver nanoparticulate material, at least one electrically conductive microparticulate material, and less than about 3% wt of an organic or polymeric resin, wherein the composition has a curing temperature of less than about 200° C.

2. The composition of claim 1, wherein the composition is substantially free of the organic or polymeric resin.

3. The composition of claim 1, wherein the silver nanoparticulate material and the conductive microparticulate material comprise different materials.

4. The composition of claim 1, wherein the silver nanoparticulate material has an average diameter less than about 20 nm.

5. The composition of claim 1, wherein the silver nanoparticulate material has an average diameter less than about 10 nm.

6. The composition of claim 1, wherein the silver nanoparticulate material sinters with the microparticulate material at a temperature lower than about 200° C.

7. The composition of claim 1, wherein the conductive microparticulate material comprises Ag, Cu, Pt, Pd, Al, Sn, In, Bi, ZnS, ITO, or combinations thereof.

8. The composition of claim 1, wherein the microparticulate material has an average diameter larger than about 1 μm but less than about 100 μm.

9. The composition of claim 1, wherein the microparticulate material has an average diameter larger than about 1 μm but less than about 50 μm.

10. The composition of claim 1, wherein the conductive microparticulate material is in the form of flakes.

11. The composition of claim 1, wherein the curing temperature is greater than about 125° C. and less than about 200° C.

12. The composition of claim 1, wherein the composition is in the form of an ink or paste.

13. The composition of claim 1, wherein the nanoparticulate material and the microparticulate material are present in substantially the same amount by weight.

14. The composition of claim 1, wherein the nanoparticulate material and the microparticulate material are present according to a weight ratio of about 1:1 to about 3:1.

15. The composition of claim 1, wherein the nanoparticulate material and the microparticulate material are present according to a weight ratio of about 2:1 to about 3:1.

16. The composition of claim 1, wherein the composition is cured and after curing has an electrical resistivity of less than about 5×10⁻⁵ Ohms-cm.

17. The composition of claim 1, wherein the composition is cured and after curing has an electrical resistivity of less than about 1.5×10⁻⁵ Ohms-cm.

18. A film comprising the composition of claim 1, wherein at least a portion of the composition is cured.

19. The film of claim 18, wherein the thickness of the film is greater or equal to about 1 μm.

20. An electronic device comprising the composition of claim 1, wherein at least a portion of the composition is cured.

21. A method of using an ink or paste, comprising:
(i) providing the ink or paste comprising at least one silver nanoparticulate material, at least one electrically conductive microparticulate material, and less than about 3% wt of an organic or polymeric resin; and
(ii) curing the ink or paste at a temperature at lower than about 200° C.

22. The method of claim 21, wherein the ink or paste is substantially free of the organic or polymeric resin.

23. The method of claim 21, wherein the step of curing further comprises sintering the at least one silver nanoparticulate material and the at least one conductive microparticulate material.

24. The method of claim 21, wherein the step of curing takes less than about 5 minutes.

25. The method of claim 21, wherein the ink or paste after curing has an electrical resistivity of less than about 5×10⁻⁵ Ohm-cm.

26. The method of claim 21, wherein the ink or paste after curing has an electrical resistivity of less than about 1.5×10⁻⁵ Ohm-cm.

27. The method of claim 21, wherein the ink or paste after curing forms a film.

28. The method of claim 21, wherein the nanoparticulate material and the microparticulate material after curing are integrated.

29. The method of claim 21, wherein the microparticulate material is in the form of flakes.

30. The method of claim 21, further comprising depositing the ink or paste onto a substrate.

31. A composition comprising at least one silver nanoparticulate material and at least one electrically conductive microparticulate material, wherein the composition is substantially free of an organic or polymeric resin.

32. The composition of claim 31, wherein conductive microparticulate material comprises Ag, Cu, Pt, Pd, Al, Sn, In, Bi, ZnS, ITO, or combinations thereof.

33. The composition of claim 31, wherein the microparticulate material is in the form of flakes.

34. The composition of claim 31, wherein the composition is sintered and after sintering the composition has a thickness of greater or equal to about 1 μm.

35. The composition of claim 31, wherein the ink or paste after curing has an electrical resistivity of less than about 5×10⁻⁵ Ohm-cm.

36. The composition of claim 31, wherein the composition is entirely free of the organic or polymeric resin.

37. A method of using an ink or paste, comprising:
(i) providing the ink or paste comprising at least one silver nanoparticulate material and at least one electrically conductive microparticulate material, wherein the ink or paste is substantially free of an organic or polymeric resin; and
(ii) sintering the silver nanoparticulate material and the conductive microparticulate material at a temperature lower than about 200° C.

38. The method of claim 37, wherein the sintering temperature is about 130° C. to about 180° C.

39. The method of claim 37, further comprising depositing the ink or paste onto a substrate via gravure printing, flexographic printing, offset printing, screen printing, or a combination thereof.

40. The method of claim 37, wherein the silver nanoparticulate material has an average diameter less than about 20 nm.

41. The method of claim 37, wherein the conductive microparticulate material has an average diameter larger than about 1 μm but less than about 100 μm.

42. The method of claim 37, wherein the ink or paste is entirely free of the organic or polymeric resin.

43. A composition comprising a plurality of particles comprising a plurality of nanoparticles and a plurality of microparticles, wherein the particles can be characterized by a particle size distribution curve comprising at least two peaks in the particle size distribution curve, wherein one peak is associated with the nanoparticles and one peak is associated with the microparticles, wherein the composition is substantially free of organic or polymeric resin.

44. An ink comprising the composition according to claim 43 and a solvent carrier for the particles.

45. A composition prepared by mixing a plurality of nanoparticles with a plurality of microparticles, the composition being substantially free of organic or polymeric resin.

46. A composition comprising a solvent carrier, and at least one silver nanoparticulate material, at least one electrically conductive microparticulate material, and less than about 3% wt of an organic or polymeric resin with respect to the weight of silver nanoparticulate material and electrically conductive microparticulate material, wherein the composition upon solvent carrier removal has a curing temperature of less than about 200° C.
